(19) United States
(12) Patent Application Publication
(10) Pub. No.: US 2014/0102973 A1
(43) Pub. Date: Apr. 17, 2014

(54) WATER PURIFYING SYSTEM

(71) Applicant: Kazuhiro Nagata, Osaka (JP)

(72) Inventor: Kazuhiro Nagata, Osaka (JP)

(21) Appl. No.: 14/112,217

(22) PCT Filed: Apr. 10, 2012
(86) PCT No.: PCT/JP2012/059819

§ 371 Date: Dec. 18, 2013

(30) Foreign Application Priority Data
Apr. 17, 2011 (JP) 2011-091622

(51) Int. Cl. C02F 1/00

(52) U.S. Cl. CPC C02F 1/002
USPC 210/416.3

(57) ABSTRACT

The purpose of the present invention is to allow victims of a disaster or the like to drink a relatively small amount of drinkable water as the temporary measure in emergency. A filter (6) into which one end part (3EP) of a hose (3) is inserted, and which is comprised of a sponge having a weight therein, is submerged into dirty water (8). When the victim releases his/her hand from a state in which he/she applies a force (F), a suction force is generated inside a pressure pump (2). By the action of the suction force, a part of the dirty water (8) which entered into the filter (6) and from which mud or the like is filtered is sucked into the hose (3) via a plurality of through-holes formed in the one end part (3EP) to flow into the pressure pump (2). The pushing force is generated manually inside the pressure pump (2) by applying the force (F). By the pushing force, filtered water inside the pressure pump (2) is discharged to a water purifier (4), and a water purifier (4) purifies the inflow water to generate drinking water although it is a small amount.

### TECHNICAL FIELD

The present invention relates to a water purifying system suitable for emergency-measure supplies and military supplies.

### BACKGROUND ART

It is the fact that survived victims who suffered natural disasters such as earthquakes encounter difficulties in obtaining drinking water even if they want to drink water to quench thirst during a period until drinking water reaches their temporary refuge shelters as relief supplies.

Alternatively, people who survived a marine disaster or a marine accident, escaped from a ship which the people had boarded, and changed to an emergency boat for several persons also encounter difficulties in obtaining drinking water even if they want to drink drinking water to quench thirst during a period of a marine drift before they are rescued.

Alternatively, in cases where battles occur in military actions, soldiers who play active roles in front lines or the like are constantly in tensed state. Thus, they may wish to quench their thirsts to calm themselves.

### REFERENCE DOCUMENTS OF CONVENTIONAL ART

### Patent Documents

[Patent Document 1] JP2008-100123A
[Patent Document 2] JUP3023422Y
[Patent Document 3] JP2007-117912A
[Patent Document 4] JP54-054444A
[Patent Document 5] JUP61-121915A
[Patent Document 6] JP10-296014A
[Patent Document 7] JP2005-279639A

### DISCLOSURE OF THE INVENTION

### Problem(s) to be Solved by the Invention

The victims and the like can quench their thirst to somewhat mentally calm themselves, even if it is temporary, if they can drink a relatively small amount of water as emergency measures during a period until drinking water arrives or during a period until they are rescued to be in circumstances to be able to drink water.

Further, the soldiers who operate in front lines may want to quench their thirsts also at places with dirty water.

However, in actual cases, it is the fact that there is no such device which can fulfill the demands in such emergencies.

Similarly, it is the fact that the above-described wishes of the soldiers who operate in front lines cannot be achieved, either.

The present invention is made in view of the current understandings, and the main purpose thereof is to provide a device which can appropriately overcome the current situations.

### SUMMARY OF THE INVENTION

A water purifying system according to the subject matter of the present invention, includes a pressure pump for generating a pushing force therein when a pressing force is applied from above and generating a suction force therein when the pressing force is not applied, and including a water intake port having a first valve that is opened by is the suction force and is closed by the pushing force, and a water discharge port having a second valve that is opened by the pushing force and is closed by the suction force, a hose having one end part and the other end part that is joined to the water intake port of the pressure pump, a filter comprised of a filter member that can filter raw water entering therein when the filter is soaked into raw water comprised of one of dirty water and sea water, wherein the one end part of the hose is inserted in the filter, and wherein the filter has therein a weight having a mass greater than buoyancies of the filter member and the hose in the raw water, a water purifier, and a connecting part mutually connecting the water discharge port of the pressure pump and the water intake port of the water purifier. The one end part of the hose has a plurality of openings through which the raw water that is entered into the filter and filtered by the filter passes to flow into the hose.

### Effect of the Invention

According to the subject matter of the present invention, victims who have suffered a natural disaster or the like, or soldiers who play active roles in front lines (hereinafter, also referred to as “the victims or the like”) can temporarily quench their thirsts yet it is a small amount compared to an amount of water which is normally taken by a person. Therefore, the water purifying system for emergency measures or military supplies, which can also calm the victims or the soldiers somewhat mentally, can be provided. Particularly, even if there is no electricity provided in that case, a drinkable quality and amount of drinking water can be generated and supplied from raw water only by a manual labor. In addition, as the water purifier is reduced in size, the water purifying system according to the subject matter of the present invention can be reduced in size to be developed into a portable water purifying system.

According to the present invention, dirty materials or planktons can certainly be filtered from dirty water or sea water which entered into the filter.

According to the present invention, parts of the filter and the hose can certainly be submerged into the raw water, and moreover, if the raw water is sea water, corrosion of the weight can be prevented.

According to the present invention, since the hose is thin and light, it can prevent that the hose takes up a space when it is not in use, and moreover, if the raw water is sea water, the hose having a high salt tolerance can be achieved.

Hereinafter, various implementations of the present invention will be described in detail with their effects and advantages, based on the accompanying drawings.

### BRIEF DESCRIPTION OF DRAWINGS

FIG. 1 is a view schematically illustrating a configuration of a water purifying system according to Embodiment 1 of the present invention.

FIG. 2 is an elevational view schematically illustrating one example of an internal configuration of a filter.

FIG. 3 is an elevational view schematically illustrating one example of the internal configuration of the filter.

### MODE(S) FOR CARRYING OUT THE INVENTION

### Embodiment 1

### <Configuration of Water Purifying System>

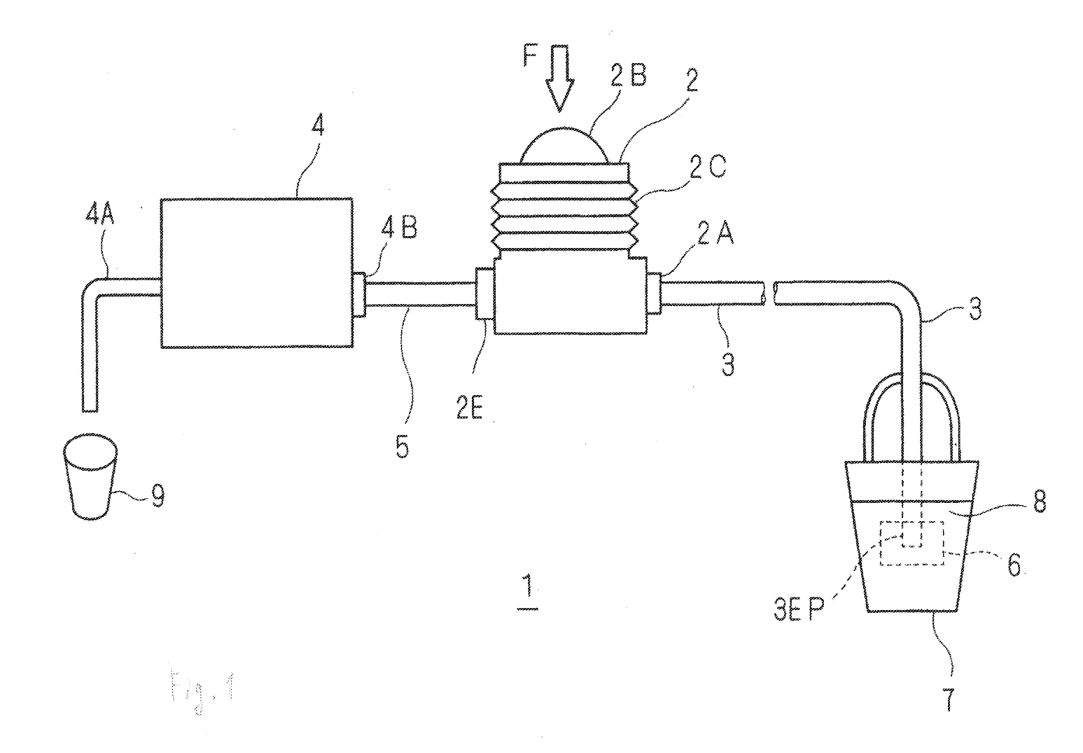

FIG. 1 is a view schematically illustrating a configuration of a water purifying system 1 according to this embodiment. In FIG. 1, when a person pushes with a force F against a top part 2B of a pump 2, the pump 2 contracts in a bellows part 2C thereof to generate a pushing force inside the pump 2. As a result, a first valve (not illustrated) inside a water intake port 2A of the pressure pump 2 is closed by the pushing force, while a second valve (not illustrated) inside a water discharge port 2E is opened by the pushing force. On the other hand, when the person stops the pushing operation with the force F, the bellows part 2C of the pump 2 extends to generate a suction force inside the pump 2. As a result, the first valve is opened, while the second valve is closed.

The other end part of a hose 3 is joined to the water intake port 2A of the pressure pump 2. On the other hand, one end part 3EP of the hose 3 constitutes a tip end part of the hose 3.

The material of the hose 3 may be polyethylene or rubber. Particularly, since the hose 3 is longer than a connecting part 5 described later, rubber which is formed in a light and narrow member is generally suitable for the material of the hose 3. Particularly, rubber is generally a material with high elasticity. Thus, if the rubber is used as the material of the hose 3, the long hose 3 will not be difficult to be handled because the hose 3 can be wound around the peripheral of the pressure pump 2 when it is not in use. In addition, when submerging the tip end part of the hose 3 into sea water, since rubber is high in salt tolerance, corrosion of the tip end part of the hose 3 can be avoided when the hose 3 is made of rubber.

A water purifier 4 generates drinkable water by applying a known water purifying operation to non-drinking water which is taken in from the water intake port 4B, and discharges the generated drinking water from the discharge part 4A.

The connecting part 5 is a part which mutually connects the water discharge port 2E of the pressure pump 2 and the water intake port 4B of the water purifier 4.

Again, describing the structure of the one end part 3EP which constitutes the tip end part of the hose 3, the one end part 3EP is entirely inserted and disposed inside the filter 6. The one end part 3EP is soaked together with the filter 6 into dirty water 8 reserved in a bucket 7. In the example of this embodiment illustrated in FIG. 1, raw water to be purified is the dirty water 8. The dirty water 8 is water which is collected from, for example, a pond, a swimming pool, an unclean river, a swamp, or a large puddle, and it is contaminated with germs, pubescences of plants, mud, gravels or the like.

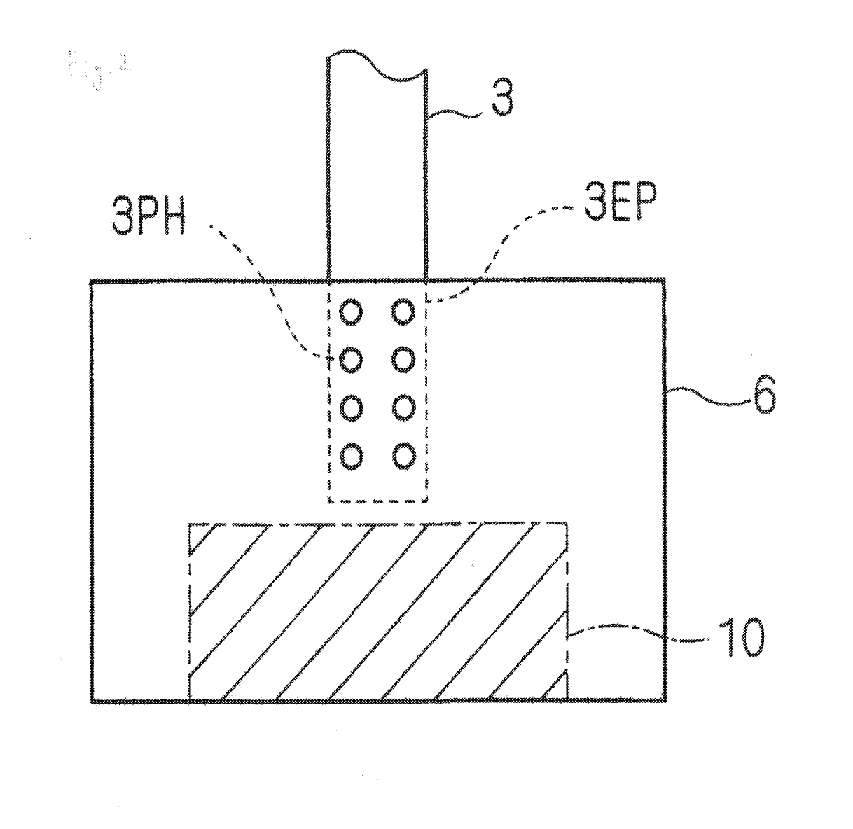

Here, FIG. 2 is an elevational view which is drawn in order to schematically illustrate the internal configuration of the filter 6. In this example, the filter 6 is comprised of a sponge (corresponding to a filter member), and filters the dirty water 8. That is, the filter 6 performs a filtering operation which traps in the filter 6 germs and the like, or solid components such as mud and gravels, contained in the dirty water 8 which entered into the filter 6.

As illustrated in FIG. 2, the entire part of the one end part 3EP which is the tip end part of the hose 3 is inserted and fixed into/to an approximately center part of the filter 6. The one end part 3EP is entirely fixed to the filter 6 comprised of the sponge by a pressure of the filter 6. A plurality of through-holes 3PH are formed as openings only in the one end part 3EP of the hose 3, throughout the one end part 3EP. Therefore, the dirty water 8 which entered into the filter 6 is filtered by the above-described action of the sponge which constitutes the member of the filter 6, and a portion of the dirty water 8 enters into the hose 3 via each of the through-holes 3PH of the one end part 3EP.

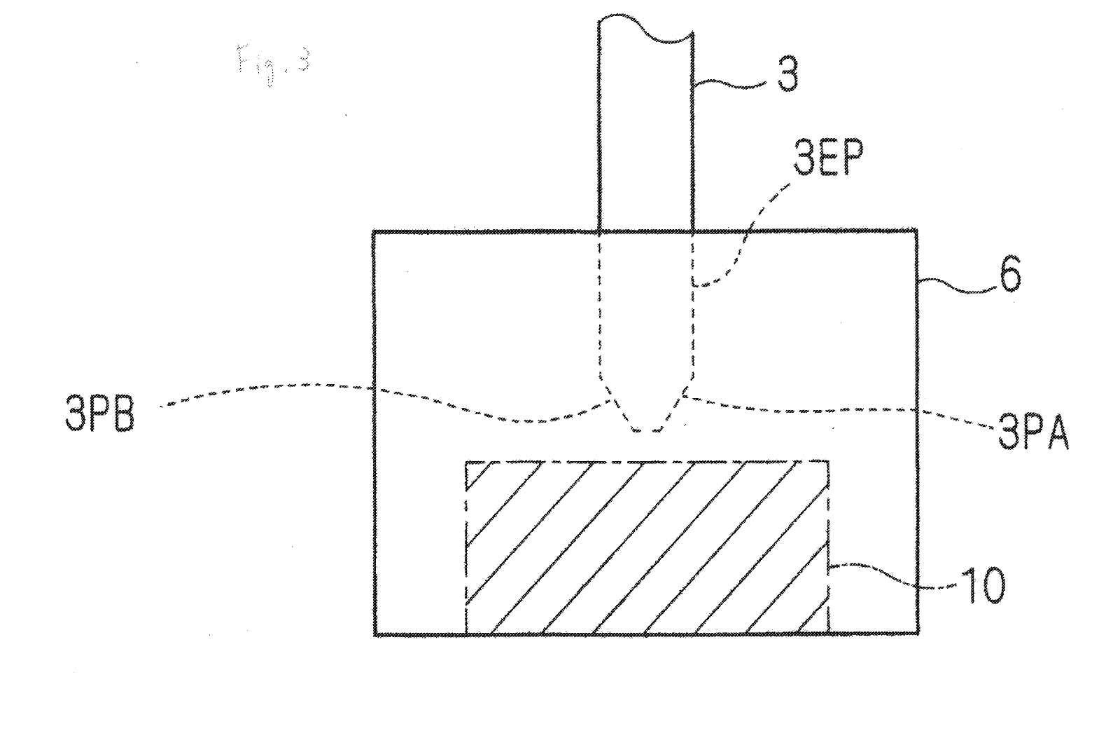

In FIG. 2, hatchings are drawn in a weight 10, for convenience of illustration. The filter 6 has the weight 10 therein. That is, the entire circumference of the weight 10 is surrounded by the filter member comprised of the sponge, and is fixed to the filter member. The weight 10 has a mass to overcome a buoyancy of the filter member and a buoyancy of the hose 3 in the dirty water (raw water) 8. Since the filter 6 has the weight 10 therein, the filter 6 entirely submerges into the dirty water 8 for sure. Here, for example, lead is used as the material of the weight 10. Lead is heavier than rubber and sponge in specific gravity and, moreover, it is not a material which is corroded and rusted due to sea water, if the raw water is sea water. In that meaning, it can be said that lead is one of suitable examples for the material of the weight 10. Note that the weight 10 may be entirely surrounded by the filter member comprised of the sponge. The same can be said in FIG. 3 as described later.

FIG. 3 is an elevational view schematically illustrating a modification of FIG. 2. In the example of FIG. 3, the one end part 3EP of the hose 3 has a first cut-off opening 3PA and a second cut-off opening 3PB opposing to the first opening 3PA as the plurality of openings, instead of the plurality of through-holes 3PH. The first and second cut-off opening 3PA and 3PB are created by cutting the one end part 3EP of the hose 3 symmetrically. Also in this case, each of the cut-off opening 3PA and 3PB allows, as the openings, the raw water which enters into the filter 6 and is filtered by the above-described action of the sponge which constitutes the filter member to flow through the hose 3.

### <Water Purifying Method of Water Purifying System>

Below, a water purifying method of the dirty water 8 by utilizing the water purifying system 1 is described with reference to FIGS. 1 and 2.

First, a victim or the like goes out carrying the bucket 7 with him/her, and scoops the dirty water 8 from a nearby pond, swimming pool or the like into the bucket 7. Then, he/she bring the bucket 7 back to a refuge shelter or the like. Then, the victim or the like soaks into the dirty water 8 the filter 6 into which the one end part 3EP of the hose 3 in the water purifying system 1 of FIG. 1 is inserted, and a part of the hose 3 which projects from an upper surface of the filter 6. In this case, since the filter 6 has the weight 10 as described above, the filter 6 and the like is certainly submerged into the dirty water 8.

Next, the victim or the like generates the pushing force inside the pressure pump 2 by applying the force F to the top part 2B of the pressure pump 2 by a hand, once and contracting the bellows part 2C of the pump 2. At this time, the first valve (not illustrated) of the water intake port 2A of the pressure pump 2 is closed and, on the other side, the second valve (not illustrated) of the water discharge port 2E is opened; however, since water has not accumulated inside the container of the pressure pump 2, water will not be discharged from the water discharge port 2E.

After that, when the victim or the like stops applying the force F to the top part 2B by hand and releases his/her hand from the top part 2B, the bellows part 2C of the contracted pressure pump 2 begins to expand upwardly and, thus, the suction force is generated inside the pressure pump 2. By this suction force, although the second valve is closed, the first valve is opened. Therefore, the suction force acts toward the one end part 3EP inside the hose 3. As a result, a part of the dirty water 8 from which dirty materials, such as mud or/and germs, are filtered after entering into the filter 6, enters into the hose 3 through each of the through-holes 3PH formed in the one end part 3EP of the hose 3 inside the filter 6. Then, the part of the dirty water 8 is drawn by the suction force to flow inside the hose 3 toward upstream thereof, and flows into the container inside the pressure pump 2 from the water intake port 2A to be accumulated.

Further, the victim or the like again applies the force F to the top part 2B of the pressure pump 2 by hand to generate the pushing force inside the pressure pump 2. By the pressing, the first valve is closed while the second valve is opened. Therefore, the filtered water accumulated in the container inside the pressure pump 2 flows out from the water discharge port 2E by the pushing force, flows through the inside of the connecting part 5, and flows into the water purifier 4 from the water intake port 4B of the water purifier 4. Then, the water purifier 4 generates drinking water by performing the known water purifying processing to the non-drinking water which flowed in, and discharges the generated drinking water from the discharge part 4A. If the victim or the like catches the drinking water with the paper cup 9, a small amount of drinking water can be collected in the paper cup 9.

The victim or the like continues performing the series of operations manually to be able to collect a considerable amount of drinking water in the paper cup 9. Thus, he/she can drink the drinking water to quench his/her thirst. The victim or the like can generate approximately several liters of drinking water per day for temporary emergency measures without the necessity of electricity only by intermittently performing such a manual operation.

Further, when considering sea water as the raw water instead of the dirty water 8, a person who is aboard on a boat from a ship in emergency due to a marine disaster or the like, he/she can use the water purifying system 1 on the boat to filter planktons and the like contained in the sea water by the filter 6 which is soaked in the sea water and accumulate the sea water in the container inside the pressure pump 2 via the hose 3. Then, the victim or the like is able to drink the clean water after salt and the like is further removed by the water purifier 4 as temporary drinking water until he/she is rescued.

Note that the system 1 can be reduced in size to be portable as the size of the water purifier 4 is reduced. That is, if the water purifier 4 has a portable water purifier main body, the system 1 can be a portable water purifying system to be a user-friendly water purifying system.

### (Additional Remarks)

Note that the device comprised of parts of the water purifying system excluding the water purifier is defined as a “water-sucking and filtering apparatus used as an early-stage of the water purifier of the water purifying system.”

As described above, although the embodiments of the present invention are disclosed and described in detail, the above description illustrates aspects to which the present invention is applicable and, thus, the present invention is not limited to the above description. That is, it is possible to consider various changes and/or modifications which are made to the described aspects, without departing from the scope of the present invention.

### INDUSTRIAL APPLICABILITY

The water purifying system according to the present invention is suitable for the application to the water purification system for allowing victims of a disaster or the like to temporarily drink drinking water.

Further, the present invention can also be applied to portable water purifying systems as military supplies which, when soldiers operating in front lines or the like found dirty water, for example, in a jungle, they can temporarily quench their thirsts with the dirty water to temporarily calm themselves.

### DESCRIPTION OF REFERENCE NUMERALS

1 Water Purifying System
2 Pressure Pump
3 Hose
3EP One End Part (Tip End Part)
3PH Through-Hole (Opening)
3PA First Cut-Off Opening (Opening)
3PB Second Cut-Off Opening (Opening)
4 Water Purifier
5 Connecting Part
6 Filter
8 Dirty Water
10 Weight

1. A water purifying system, comprising:
a pressure pump for generating a pushing force therein when a pressing force is applied from above and generating a suction force therein when the pressing force is not applied, and comprising a water intake port including a first valve that is opened by is the suction force and is closed by the pushing force, and a water discharge port including a second valve that is opened by the pushing force and is closed by the suction force;
a hose including one end part and the other end part joined to the water intake port of the pressure pump;
a filter comprised of a filter member that can filter raw water entering therein when the filter is soaked into raw water comprised of one of dirty water and sea water, wherein the one end part of the hose is inserted in the filter, and wherein the filter includes therein a weight having a mass greater than buoyancies of the filter member and the hose in the raw water;
a water purifier; and
a connecting part mutually connecting the water discharge port of the pressure pump and the water intake port of the water purifier,
wherein the one end part of the hose includes a plurality of openings through which the raw water that is entered into the filter and filtered by the filter passes to flow into the hose.

2. The water purifying system of claim 1, wherein the filter member is comprised of a sponge.

3. The water purifying system of claim 1, wherein the weight is made of lead.

4. The water purifying system of claim 1, wherein the hose is made of rubber.

5. The water purifying system of claim 1, wherein the plurality of openings include a plurality of through-holes.

6. The water purifying system of claim 1, wherein the plurality of openings includes:
a first cut-off opening located in one of a tip end part of the one end part of the hose; and
a second cut-off opening located in the other tip end part of the one end part of the hose, opposing to the first cut-off opening.

7. The water purifier used for the water purifying system of claim 1, comprising a portable water purifier main body.

8. A water-sucking and filtering apparatus used as an early-stage of the water purifier of the water purifying system of claim 1, comprising:
a pressure pump for generating a pushing force therein when a pressing force is applied from above and generating a suction force therein when the pressing force is not applied, and comprising a water intake port including a first valve that is opened by is the suction force and is closed by the pushing force, and a water discharge port including a second valve that is opened by the pushing force and is closed by the suction force;
a hose including one end part and the other end part joined to the water intake port of the pressure pump;
a filter comprised of a filter member that can filter raw water entering therein when the filter is soaked into raw water comprised of one of dirty water and sea water, wherein the one end part of the hose is inserted in the filter, and wherein the filter includes therein a weight having a mass greater than buoyancies of the filter member and the hose in the raw water; and
a connecting part mutually connecting the water discharge port of the pressure pump and the water intake port of the water purifier,
wherein the one end part of the hose includes a plurality of openings through which the raw water that is entered into the filter and filtered by the filter passes to flow into the hose.
